(19) United States
(12) Patent Application Publication
(10) Pub. No.: US 2024/0081362 A1
(43) Pub. Date: Mar. 14, 2024

(54) Natural Tea Beverage

(71) Applicant: Ericka Ennis-Harris, Lynchburg, VA (US)

(72) Inventor: Ericka Ennis-Harris, Lynchburg, VA (US)

(21) Appl. No.: 18/351,552

(22) Filed: Jul. 13, 2023

Related U.S. Application Data
(60) Provisional application No. 63/404,688, filed on Sep. 8, 2022.

(51) Int. Cl. A23F 3/40; A23F 3/16

(52) U.S. Cl. CPC A23F 3/405; A23F 3/16

(57) ABSTRACT

The present invention relates to a tea beverage. The beverage may have a plurality of flavor profiles in differing embodiments including, but not limited to, lemon, peach, raspberry, cherry, and mango. Each embodiment is preferably comprised of a tea base, lemon juice, lime juice, and sugar. The cherry and mango embodiments are additionally comprised of grenadine or mango syrup.

### CROSS-REFERENCE TO RELATED APPLICATION

The present application claims priority to, and the benefit of, U.S. Provisional Application No. 63/404,688, which was filed on Sep. 8, 2022, and is incorporated herein by reference in its entirety.

### FIELD OF THE INVENTION

The present invention relates generally to the field of tea. More specifically, the present invention relates to a tea beverage. The beverage may have a plurality of flavor profiles in differing embodiments including, but not limited to, lemon, peach, raspberry, cherry, and mango. Each embodiment is preferably comprised of a tea base, lemon juice, lime juice, and sugar. The cherry and mango embodiments are additionally comprised of grenadine or mango syrup. Accordingly, the present disclosure makes specific reference thereto. Nonetheless, it is to be appreciated that aspects of the present invention are also equally applicable to other like applications, devices, and methods of manufacture.

### BACKGROUND

Many individuals enjoy drinking sweet tea to quench their thirst. However, bottled tea beverages can contain significant preservatives and chemicals. This is undesirable for individuals who wish to or must avoid said preservatives and chemicals due to dietary restrictions. As a result, many individuals may be looking for a newer, more natural tea beverage.

Therefore, there exists a long-felt need in the art for an improved tea beverage. There also exists a long-felt need in the art for a natural tea beverage that does not contain significant preservatives and chemicals. There also exists a long-felt need in the art for a natural tea beverage made from a plurality of natural ingredients. In addition, there exists a long-felt need in the art for a tea beverage that has a plurality of flavors.

The subject matter disclosed and claimed herein, in one embodiment thereof, comprises a tea beverage. The beverage may have a plurality of flavor profiles in differing embodiments including, but not limited to, lemon, peach, raspberry, cherry, and mango. In the lemon, peach, and raspberry embodiments, the beverage is made from a lemon, peach, or raspberry tea base combined with lemon juice, lime juice, and sugar. In the cherry and mango embodiments, the beverage is comprised of a lemon tea base, lemon juice, lime juice, sugar, and the addition of grenadine or mango flavored syrup.

In this manner, the tea beverage of the present invention accomplishes all the foregoing objectives and provides an improved tea beverage that does not contain significant preservatives and chemicals. In addition, the beverage is made from a plurality of natural ingredients. The beverage also has a plurality of flavors.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tea beverage. The beverage may have a plurality of flavor profiles in differing embodiments including, but not limited to, lemon, peach, raspberry, cherry, and mango. In a first embodiment, the beverage is in the form of a lemon flavored tea beverage. The beverage is comprised of a lemon flavored tea base having some combination of citric acid, corn syrup, carrot juice, potassium, sorbate, and lemon flavoring. In this embodiment, the beverage is also comprised of some combination of lemon juice, lemon juice, and sugar (preferably pure cane sugar).

In a second embodiment, the beverage is in the form of a peach flavored tea beverage. The beverage is comprised of a peach flavored tea base having some combination of citric acid, corn syrup, carrot juice, potassium, sorbate, and lemon flavoring. In this embodiment, the beverage is also comprised of some combination of lemon juice, lemon juice, and sugar (preferably pure cane sugar).

In a third embodiment, the beverage is in the form of a raspberry flavored tea beverage. The beverage is comprised of a raspberry flavored tea base having some combination of citric acid, corn syrup, carrot juice, potassium, sorbate, and lemon flavoring. In this embodiment, the beverage is also comprised of some combination of lemon juice, lemon juice, and sugar (preferably pure cane sugar).

In a fourth embodiment, the beverage is in the form of a cherry flavored tea beverage. The beverage is comprised of a lemon flavored tea base having some combination of citric acid, corn syrup, carrot juice, potassium, sorbate, and lemon flavoring. In this embodiment, the beverage is also comprised of some combination of lemon juice, lemon juice, sugar (preferably pure cane sugar), and grenadine.

In a fifth embodiment, the beverage is in the form of a mango flavored tea beverage. The beverage is comprised of a lemon flavored tea base having some combination of citric acid, corn syrup, carrot juice, potassium, sorbate, and lemon flavoring. In this embodiment, the beverage is also comprised of some combination of lemon juice, lemon juice, sugar (preferably pure cane sugar), and mango flavored syrup.

Accordingly, the tea beverage of the present invention is particularly advantageous as it provides an improved tea beverage that does not contain significant preservatives and chemicals. The beverage is also made from a plurality of natural ingredients and has a plurality of flavors. In this manner, the tea beverage overcomes the limitations of existing tea beverages known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of a first potential embodiment of a tea beverage of the present invention in accordance with the disclosed architecture;

FIG. 2 illustrates a graphical view of a second potential embodiment of a tea beverage of the present invention in accordance with the disclosed architecture;

FIG. 3 illustrates a graphical view of a third potential embodiment of a tea beverage of the present invention in accordance with the disclosed architecture;

FIG. 4 illustrates a graphical view of a fourth potential embodiment of a tea beverage of the present invention in accordance with the disclosed architecture;

FIG. 5 illustrates a graphical view of a fifth potential embodiment of a tea beverage of the present invention in accordance with the disclosed architecture; and

FIG. 6 illustrates a perspective view of a container of a potential embodiment of a tea beverage of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved tea beverage. There also exists a long-felt need in the art for a natural tea beverage that does not contain significant preservatives and chemicals. There also exists a long-felt need in the art for a natural tea beverage made from a plurality of natural ingredients. In addition, there exists a long-felt need in the art for a tea beverage that has a plurality of flavors.

The present invention, in one exemplary embodiment, is comprised of a tea beverage. The beverage may have a plurality of flavor profiles. Said profiles include, but are not limited to, lemon, peach, raspberry, cherry, and mango. In a first embodiment, the beverage is in the form of a lemon flavored tea beverage. The beverage is comprised of a lemon flavored tea base having some combination of citric acid, corn syrup, carrot juice, potassium, sorbate, and lemon flavoring. In this embodiment, the beverage is also comprised of some combination of lemon juice, lemon juice, and sugar (preferably pure cane sugar).

In a second embodiment, the beverage is in the form of a peach flavored tea beverage. This embodiment is achieved by substituting the lemon flavored tea base with a peach flavored tea base. In a third embodiment, the beverage is in the form of a raspberry flavored tea beverage. This embodiment is achieved by substituting the lemon flavored tea base with a raspberry flavored tea base.

In a fourth embodiment, the beverage is in the form of a cherry flavored tea beverage. This embodiment is comprised of a lemon flavored tea base having some combination of citric acid, corn syrup, carrot juice, potassium, sorbate, and lemon flavoring. In this embodiment, the beverage is also comprised of some combination of lemon juice, lemon juice, sugar (preferably pure cane sugar), and grenadine.

In a fifth embodiment, the beverage is in the form of a mango flavored tea beverage. In this embodiment, the beverage is in the form of a cherry flavored tea beverage comprised of a lemon flavored tea base having some combination of citric acid, corn syrup, carrot juice, potassium, sorbate, and lemon flavoring. In this embodiment, the beverage is also comprised of some combination of lemon juice, lemon juice, sugar (preferably pure cane sugar), and mango flavored syrup.

Accordingly, the tea beverage of the present invention is particularly advantageous as it provides an improved tea beverage that does not contain significant preservatives and chemicals. The beverage is also made from a plurality of natural ingredients and has a plurality of flavors. In this manner, the tea beverage overcomes the limitations of existing tea beverages known in the art.

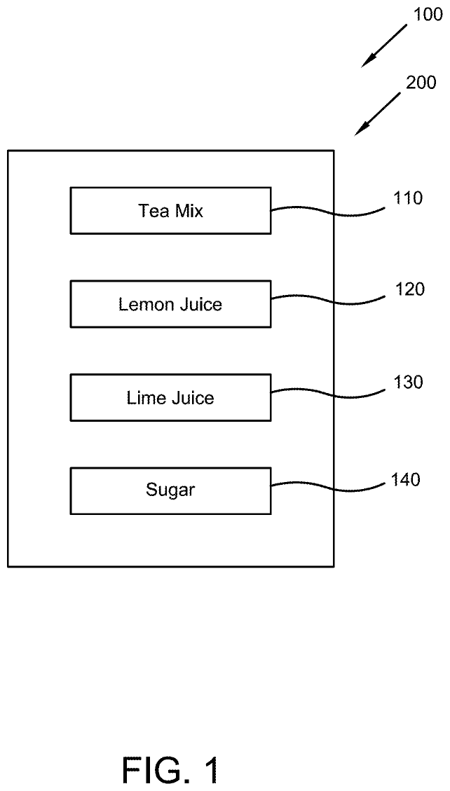

Referring initially to the drawings, FIG. 1 illustrates a graphical view of a first potential embodiment of a tea beverage 100 of the present invention in accordance with the disclosed architecture. The beverage 100 is comprised of a tea beverage. The beverage 100 may have a plurality of flavor profiles in differing embodiments.

In a first embodiment 200, the beverage 100 is comprised of a lemon flavored tea beverage. In this embodiment 200, the recipe for the beverage 100 is as follows:
1. 2.5 cups of lemon flavored tea mix 110, the mix comprises, but is not limited to, citric acid, corn syrup, carrot juice, potassium, sorbate, and lemon flavoring
2. 0.25 cups of lemon juice 120
3. 0.25 cups of lime juice 130
4. 4 cups sugar 140 (preferably, but not limited to, pure cane sugar 140)

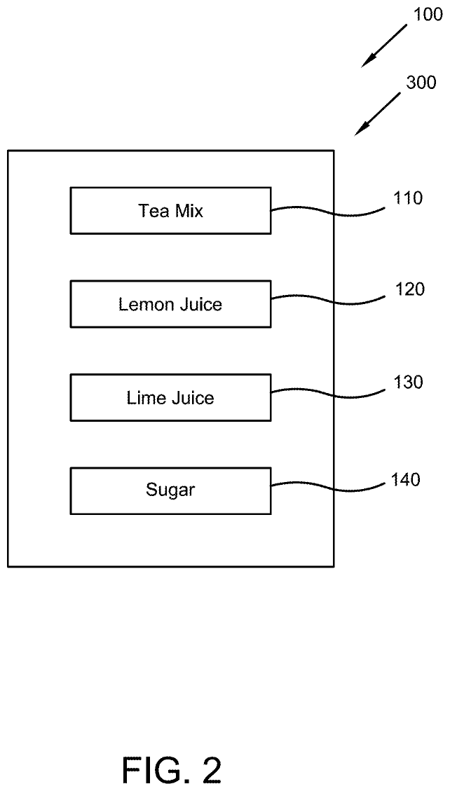

In a second embodiment 300, the beverage 100 is comprised of a peach flavored tea beverage. In this embodiment 300, the recipe for the beverage 100 is as follows (as seen in FIG. 2):
1. 2.5 cups of peach flavored tea mix 110, the mix comprises, but is not limited to, citric acid, corn syrup, carrot juice, potassium, sorbate, and peach flavoring
2. 0.25 cups of lemon juice 120
3. 0.25 cups of lime juice 130
4. 4 cups sugar 140 (preferably, but not limited to, pure cane sugar 140)

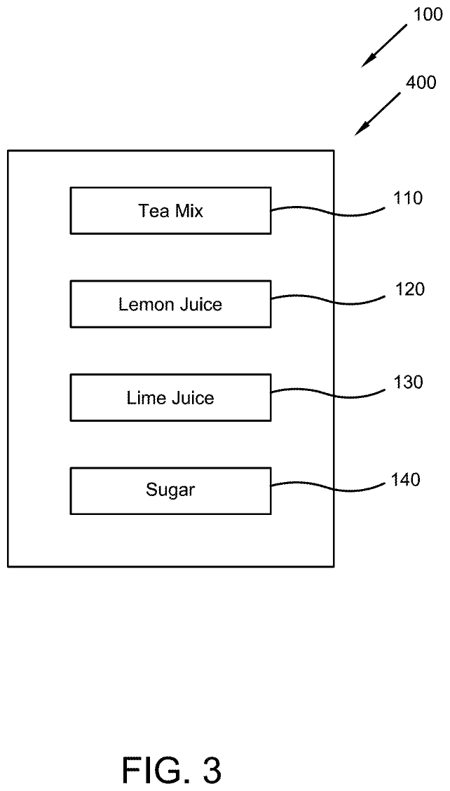

In a third embodiment 400, the beverage 100 is comprised of a raspberry flavored tea beverage. In this embodiment 400, the recipe for the beverage 100 is as follows (as seen in FIG. 3):
1. 2.5 cups of raspberry flavored tea mix 110, the mix comprises, but is not limited to, citric acid, corn syrup, carrot juice, potassium, sorbate, and raspberry flavoring
2. 0.25 cups of lemon juice 120
3. 0.25 cups of lime juice 130
4. 4 cups sugar 140 (preferably, but not limited to, pure cane sugar 140)

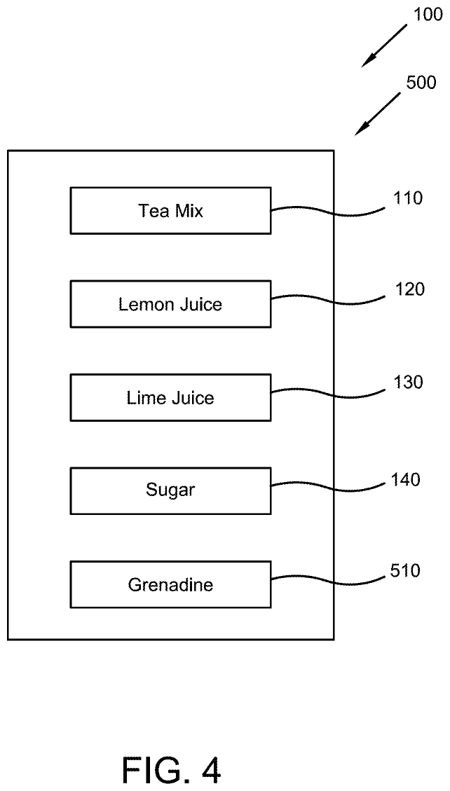

In a fourth embodiment 500, the beverage 100 is comprised of a cherry flavored tea beverage. In this embodiment 500, the recipe for the beverage 100 is as follows (as seen in FIG. 4):
1. 2.5 cups of lemon flavored tea mix 110, the mix comprises, but is not limited to, citric acid, corn syrup, carrot juice, potassium, sorbate, and lemon flavoring
2. 0.25 cups of lemon juice 120
3. 0.25 cups of lime juice 130
4. 4 cups sugar 140 (preferably, but not limited to, pure cane sugar 140)
5. 2 cups grenadine 510

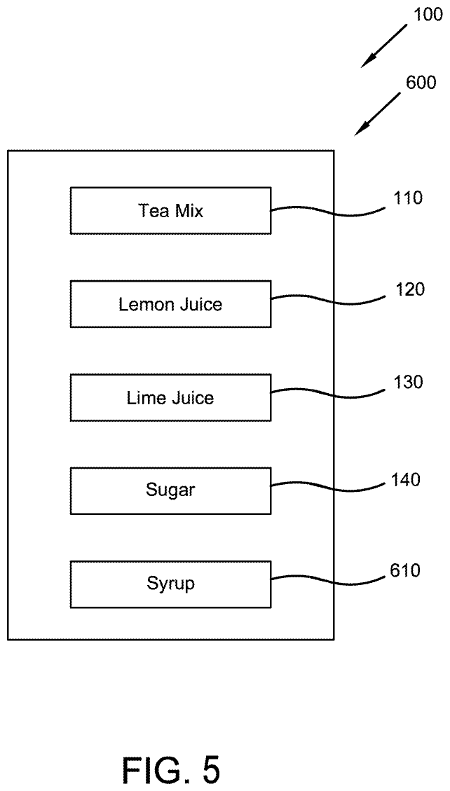

In a fifth embodiment 600, the beverage 100 is comprised of a mango flavored tea beverage. In this embodiment 600, the recipe for the beverage 100 is as follows (as seen in FIG. 5):
1. 2.5 cups of lemon flavored tea mix 110, the mix comprises, but is not limited to, citric acid, corn syrup, carrot juice, potassium, sorbate, and lemon flavoring
2. 0.25 cups of lemon juice 120
3. 0.25 cups of lime juice 130
4. 4 cups sugar 140 (preferably, but not limited to, pure cane sugar 140)
5. 1.5 cups mango syrup 610 (or mango flavored syrup).

Each embodiment makes 16 fluid ounces of the beverage 100. It should be appreciated that the exact proportions of ingredients may differ in different embodiments.

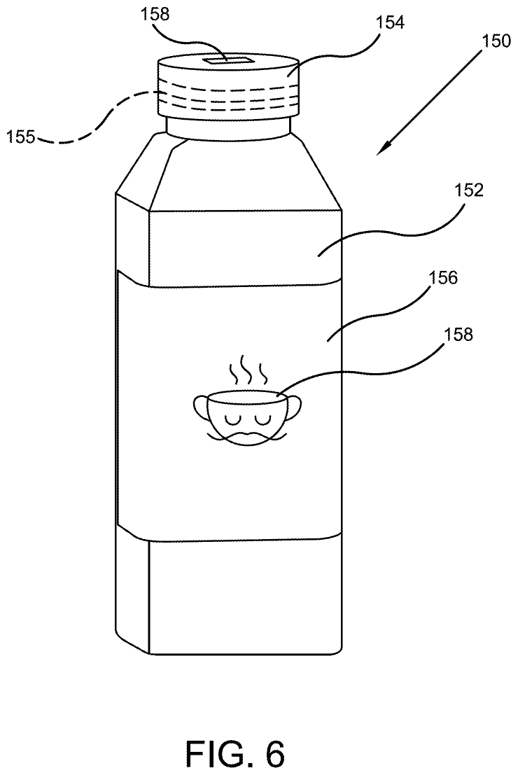

The beverage 100 is also comprised of a beverage container 150, as seen in FIG. 6. The beverage container 150 is preferably in the form of a bottle. The container 150 may be made from an opaque, a transparent, or a semi-opaque plastic material, or other bottle/container material of the like. The body 152 of the container 150 is preferably cylindrical in shape. The container 150 is also comprised of a cap 154. The cap 154 preferably attaches to the body via a pair of reciprocating threads 155 found on the cap 154 and the body 152.

The body 152 may also be comprised of at least one label 156. The label 156 may have at least one indicia 158 such as, but not limited to, an image, a picture, words, colors, patterns, nutritional information, etc. Said indicia 158 may also be found on the cap 154. The body 152, cap 154, and label 156 may be any color or pattern known in the art. In the preferred embodiment, the indicia 158 is in the form of a steaming cup.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tea beverage” and “beverage” are interchangeable and refer to the tea beverage 100 of the present invention.

Notwithstanding the foregoing, the tea beverage 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tea beverage 100 as shown in the FIGS. are for illustrative purposes only, and that many other sizes and shapes of the tea beverage 100 are well within the scope of the present disclosure. Although the dimensions of the tea beverage 100 are important design parameters for user convenience, the tea beverage 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tea beverage comprising:
a tea mix;
a lemon juice;
a lime juice; and
a sugar.

2. The tea beverage of claim 1, wherein the tea mix is comprised of a lemon flavored tea mix.

3. The tea beverage of claim 2, wherein the lemon flavored tea mix is comprised of a citric acid, a corn syrup, a carrot juice, a potassium, a sorbate and a lemon flavoring.

4. The tea beverage of claim 1, wherein the tea mix is comprised of a peach flavored tea mix.

5. The tea beverage of claim 4, wherein the peach flavored tea mix is comprised of a citric acid, a corn syrup, a carrot juice, a potassium, a sorbate, and a peach flavoring.

6. The tea beverage of claim 1, wherein the tea mix is comprised of a raspberry flavored tea mix.

7. The tea beverage of claim 6, wherein the raspberry flavored tea mix is comprised of a citric acid, a corn syrup, a carrot juice, a potassium, a sorbate, and a raspberry flavoring.

8. The tea beverage of claim 1, wherein the lemon juice is comprised of 0.25 cups of the lemon juice.

9. The tea beverage of claim 1, wherein the lime juice is comprised of 0.25 cups of the lime juice.

10. A tea beverage comprising:
a tea mix;
a lemon juice;
a lime juice;
a sugar; and
a grenadine.

11. The tea beverage of claim 10, wherein the tea mix is comprised of a lemon flavored tea mix.

12. The tea beverage of claim 10, wherein the tea mix is comprised of 2.5 cups of the tea mix.

13. The tea beverage of claim 10, wherein the lemon juice is comprised of 0.25 cups of the lemon juice.

14. The tea beverage of claim 10, wherein the lime juice is comprised of 0.25 cups of the lime juice.

15. The tea beverage of claim 10, wherein the sugar is comprised of 4 cups of a pure cane sugar.

16. The tea beverage of claim 10, wherein the grenadine is comprised of 2 cups of the grenadine.

17. A tea beverage comprising:
a tea mix;
a lemon juice;
a lime juice;
a sugar; and
a syrup.

18. The tea beverage of claim 17, wherein the tea mix is comprised of a lemon flavored tea mix.

19. The tea beverage of claim 17, wherein the syrup is comprised of a mango syrup.

20. The tea beverage of claim 17, wherein the syrup is comprised of 1.5 cups of the syrup.
